(19) United States
(12) Patent Application Publication
(10) Pub. No.: US 2003/0079612 A1
(43) Pub. Date: May 1, 2003

(54) Self-contained vending machine for beverages

(76) Inventor: Alfredo Con, Los Angeles, CA (US)

Correspondence Address: PATENT ADMINSTRATOR, KATTEN MUCHIN ZAVIS ROSENMAN, 525 WEST MONROE STREET, SUITE 1600, CHICAGO, IL, 60661-3693, US

(21) Appl. No.: 10/281,326

(22) Filed: Oct. 28, 2002

Related U.S. Application Data
(60) Provisional application No. 60/346,010, filed on Oct. 29, 2001.
(60) Provisional application No. 60/330,921, filed on Nov. 2, 2001.
(60) Provisional application No. 60/330,944, filed on Nov. 2, 2001.

(51) Int. Cl. A23L 1/00

(52) U.S. Cl. 99/275

(57) ABSTRACT

An apparatus for preparing and vending beverages based on selections input by consumers is provided, including one or more sources of roasted coffee beans; one or more sources of teas; one or more sources of cocoa; at least one grinder for preparing ground coffee from said roasted coffee beans; one or more sources of flavoring ingredients; a source of water; one or more sources of fresh dairy products; and a mechanism for preparing the beverage. Also provided is a method for preparing a beverage according to selections entered by a consumer, including receiving beverage selections entered by a consumer; collecting payment for the beverage based on the beverage selections entered; retrieving preset standards for proper preparation of the beverage based on the beverage selections; displaying the beverage preparation process and the freshness of ingredients used to prepare the beverage; preparing the beverage in accordance with the preset standards; monitoring the preparation of the beverage for compliance with the preset standards; and providing the beverage to the consumer.

This application claims the benefit of priority from U.S. Provisional Appln. No. 60/346,010 filed on Oct. 29, 2001, U.S. Provisional Appln. No. 60/330,921 filed on Nov. 2, 2001, and U.S. Provisional Appln. No. 60/330,944 also filed on Nov. 2, 2001.

### BACKGROUND OF THE INVENTION

1. Field of the Invention

The present invention relates to method and apparatus for vending and dispensing beverages, particularly hot beverages. In particular, the present invention relates to method and apparatus for providing espresso and coffee beverages, including without limitation those prepared with fresh dairy products, thus improving the quality of the beverage being prepared. The invention also relates to a method and apparatus for cleaning or sanitizing a beverage vending apparatus, a method and apparatus for displaying a process of preparing a beverage within a vending apparatus, and a quality control system and method for monitoring the quality of beverages prepared by a vending device. The method and apparatus for vending and dispensing beverages may allow the beverage preparation to be viewed and/or monitored externally, thereby confirming the proper preparation of the beverage and the freshness of the ingredients used to prepare the beverage.

2. Related Art

In U.S. Pat. Nos. 6,019,032 and 6,099,878, both to Arksey, a tabletop system for extracting espresso automatically is described. The system includes a milk delivery system, and is said to be durable because it does not use venturi technology. However, the system is not designed to function as a standalone vending machine, and it does not display the beverage preparation process to the consumer, demonstrate the freshness of the ingredients or the beverage preparation process to the consumer, or provide the beverage in a cup having a lid. It also fails to provide a quality control feedback system. The device may not be left unattended for more than a few hours, as it fails to isolate components and byproducts that become contaminated with bacteria.

U.S. Pat. No. 5,207,148 to Anderson et al. describes an automatic tabletop system for extracting espresso that includes a milk delivery system based on venturi technology. The system is not configured to operate as a standalone, self-contained vending device. It does not display the beverage preparation process, or the source of fresh milk. It also does not permit quality control feedback. The beverage is not provided to the recipient in a cup with a lid. This device is also not able to be left unattended for more than a few hours, as it fails to isolate components and byproducts that become contaminated with bacteria.

U.S. Pat. No. 6,182,555 to Scheer et al. relates to a tabletop, automatic device for brewing tea or coffee. The device is adapted for preparation of tea or coffee using infusion brewing, and provides a simple window for viewing the uncomplicated infusion brewing process. The device does not manipulate the medium by tamping or shaping the grounds after they are dropped into the brewing chamber and water starts to flow through the medium. The device is therefore not adapted for preparing beverages by other methods, such as the espresso process, the coffee press process, or the vacuum pot process. The device is also not adapted for use in grinding coffee beans. The device does include the ability to add flavorings and sweeteners to the beverage, but does not incorporate a milk delivery system. The device is not designed to function as a self-contained vending apparatus having a quality control system.

None of these patents describes or suggests the need for a self-contained vending apparatus for providing beverages, where the beverages are prepared using fresh dairy products. Additionally, none of the patents describes or suggests the need for a self-contained vending apparatus that may be left unattended for more than a few hours by isolating components and byproducts that become contaminated with bacteria. Additionally, none of the patents describes or suggests the need for a self-contained vending apparatus that include a window allowing the external observation (e.g., by a consumer or service technician) of the preparation of non-infusion beverages. Additionally, none of the patents describes or suggests the need for a self-contained vending apparatus that include displays quantifying or otherwise translating various aspects (such as water pressure or tamping pressure of coffee grounds) of the beverage-preparation process. Additionally, none of the patents provides the beverage to the recipient in a cup having a lid. Further, none of the patents includes software routines and apparatus for monitoring and adjusting beverage preparation, a quality control feedback system and method, or means for demonstrating to the recipient the freshness of the ingredients and use of proper preparation technique.

Therefore, there is a need for a self-contained vending machine and method of preparing beverages, including without limitation infusion or brewed beverages, and non-infusion beverages such as beverages prepared using the espresso process, the coffee press process, or the vacuum pot process. These beverages may be prepared using fresh dairy products. There is also a need to provide a self-contained vending machine and method of preparing beverages, wherein the process is monitored using a software routine for adjusting beverage preparation. There is further a need for a self-contained vending apparatus wherein the quality of the ingredients and proper preparation technique are visually demonstrated to the recipient of the beverage, and for a vending machine including a quality control system for obtaining feedback regarding beverage and machine quality. These and other needs in the art are addressed by the methods and apparatus of this invention, as will be set forth below.

### SUMMARY OF THE INVENTION

It is an object of the present invention to provide a self-contained vending machine and a method for preparing beverages, particularly espresso and other coffee beverages, optionally including fresh dairy products. Such methods and apparatus preferably also provide features including one or more of a self-cleaning feature, a quality control feedback feature, and a visual confirmation of proper preparation technique and ingredient freshness.

According to a first aspect of this invention, a self-contained, standalone apparatus for automatically preparing and vending beverages based on selections input by consumers, including one or more sources of roasted coffee beans; one or more sources of teas; one or more sources of cocoa; at least one grinder for preparing ground coffee from said roasted coffee beans; one or more sources of flavoring ingredients; a source of water; one or more sources of fresh dairy products; and a mechanism for preparing the beverage.

According to a second aspect of this invention, a self-contained beverage vending device includes a mechanism for preparing the beverage, said mechanism having means for monitoring the preparation of the selected beverage; means for storing preset standards for proper preparation of the selected beverage; and means for comparing the monitored preparation of the beverage with the stored standards for preparation of the beverage, and adjusting the preparation of the beverage so that said beverage is prepared in compliance with the standards.

Yet another aspect of the invention relates to a feedback system for monitoring a standalone beverage vending apparatus, said system including means for requesting that information be input to indicate a degree of satisfaction with one or more aspects of the apparatus selected from the group consisting of quality of beverage, quality of ingredients, and satisfaction with value received; means for inputting the requested information regarding consumer satisfaction; and means for preparing a summary of information input by consumer.

Still a further aspect of the invention relates to a method for automatically preparing a beverage according to beverage selections entered by a consumer, including the steps of receiving the beverage selections entered by a consumer; retrieving preset standards for proper preparation of the beverage based on the beverage selections input by the consumer; displaying to the consumer the beverage preparation process and the freshness of ingredients being used to prepare the beverage; preparing the beverage in accordance with the preset standards; monitoring the preparation of the beverage to ensure that said beverage is prepared in compliance with the preset standards; and providing said beverage to the consumer.

According to a still further aspect of this invention, a computer system for monitoring and adjusting the production of beverages includes sensors for detecting actual status of all sources of ingredients used in preparing a selected beverage; sensors for monitoring actual functioning and actual status of mechanisms during preparation of the selected beverage; memory comprising stored software including preset status and preset functioning information corresponding to the selected beverage; and a processor for comparing the actual status and actual functioning of the ingredients and mechanisms involved in beverage production to the preset status and preset functioning of the ingredients and mechanisms stored in memory, wherein when the actual status of the sources of ingredients is not substantially identical to the preset status of the sources of ingredients, an error message is generated to indicate that the sources of ingredients require servicing, and wherein when the actual functioning and the actual status of the mechanisms used to prepare the beverage are not substantially identical to the preset functioning and preset status, a message is delivered to the mechanisms indicating adjustments to be made for the preparation of the beverage.

Another aspect of the invention relates to a cleaning system for use in an automatic, self-contained beverage vending machine that prepares beverages using fresh dairy products, said system including a sterilization flusher for providing a cleaning flush of beverage preparation components contained in said vending machine; and a receptacle for storing waste generated during the cleaning flush, as well as fluids leaked from the beverage preparation components during preparation of the beverage.

These and other aspects of the invention will be described in more detail below in connection with the attached Figures.

### BRIEF DESCRIPTION OF THE DRAWINGS

The advantageous structure and/or function according to the present invention will be more easily understood from the following detailed description of the preferred embodiments and the appended Drawings, as follows.

FIG. 1 is a front view of a self-contained vending machine for beverages according to a presently preferred embodiment.

FIG. 2 is a side view of a self-contained vending machine for beverages according to a presently preferred embodiment.

FIG. 3 is an enlarged view of transparent areas provided in a self-contained vending machine for beverages according to a presently preferred embodiment.

FIGS. 4A through 4D are views of displays provided on a self-contained vending machine for beverages according to a presently preferred embodiment

FIG. 5 is a diagram describing the milk dispensing and selection system according to a presently preferred embodiment.

FIG. 6 is a diagram describing the relationship between components of an espresso extracting system according to a presently preferred embodiment.

FIG. 7 is a flow chart depicting a software routine for adjusting extraction of espresso according to a presently preferred embodiment.

### DETAILED DESCRIPTION OF THE PRESENTLY PREFERRED EXEMPLARY EMBODIMENTS

1. Introduction

The invention will now be described with respect to several embodiments in which standalone and/or self-contained vending apparatus and methods are utilized to prepare beverages. These apparatus and methods may include any or all of the following features:

preparation of beverages using fresh dairy products;

provision of beverages to consumers in cups having lids;

visual demonstration of ingredient freshness to consumers prior to purchase;

visual demonstration of beverage preparation process to consumers, with optional software routines for adjusting preparation;

displays that clearly convey, describe, and/or quantify one or more key aspects of the beverage preparation process;

quality control based on feedback obtained from consumers and/or service technicians regarding beverage quality and machine operation; and

cleaning of apparatus to ensure beverage safety and freshness. This invention will find applicability in many situations in which liquids are prepared and dispensed, including but not limited to liquids prepared using espresso, coffee, tea, hot chocolate, and soup, whether served hot or cold.

Before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

2. The Structure

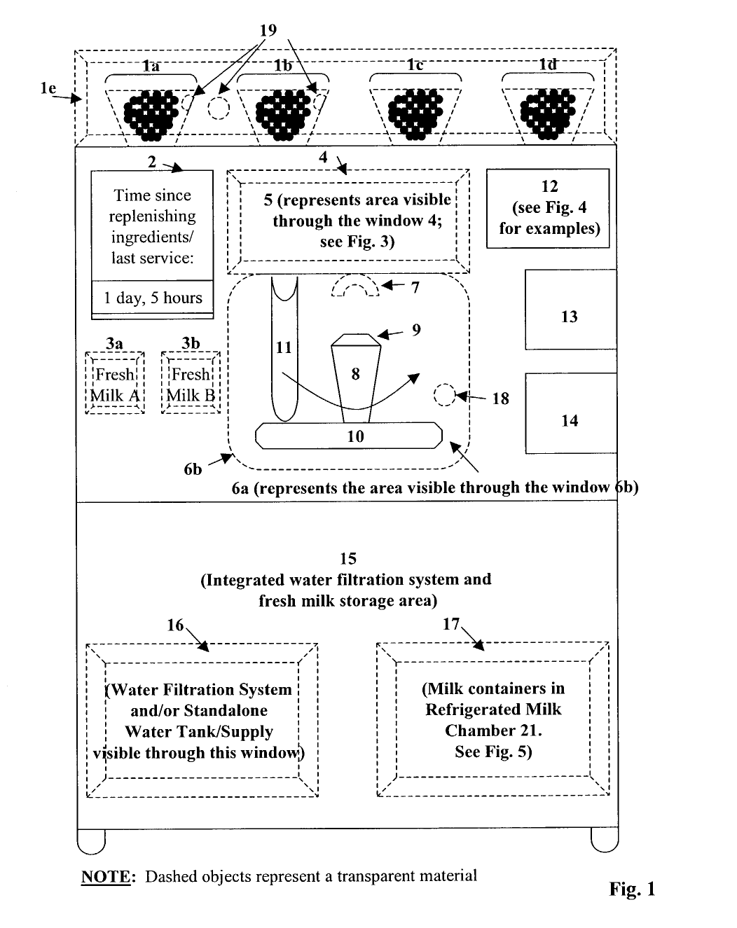

An example of a standalone beverage vending device according to a presently preferred embodiment is shown in FIG. 1. The machine includes clear containers (1a, 1b, 1c, 1d) that expose one or more, and preferably all, of the main ingredients being used. This example includes transparent exposed hoppers (1a, 1b) for one, two, or more types of coffee (e.g., regular, decaffeinated, Colombian, european, etc.). These hoppers feed into a coffee grinder (not shown). Containers may also be provided for one or more flavoring ingredients (1c, 1d) (e.g., ground chocolate powder, sugar, artificial sweeteners). The clear containers (in this example, the four hoppers) are preferably provided in a transparent enclosure (1e), which allows a clear view of the containers and prevents the consumer/purchaser from accessing their contents. The transparent enclosure is not necessary if the clear containers are secured to the machine in such a way that they do not offer easy access to their contents. The machine also optionally includes a display or area (2) that announces and/or displays how long it has been since fresh ingredients were delivered and the machine was last serviced. The display can assume various forms, such as an erasable board on which a service technician or other maintenance/service provider writes, or an electronic calendar and clock that can be reset easily at the end of every service call.

According to a particularly preferred embodiment, the machine also includes one or more sizable displays or accessories, noticeable from a distance, visually exposing and storing fresh milk and/or other fresh dairy products such as cream or half-and-half. The display can assume a variety of forms, as long as it clearly exposes fresh milk. For example, the display can include one or more see-through refrigerated vessels (3a, 3b), and/or one or more clear windows (17) exposing milk containers (e.g., standard gallon jugs, or larger bag-in-box cartons) in a refrigerated milk chamber (21). This source of fresh milk may be utilized in preparing beverages including, but not limited to, lattes, cappuccinos, and coffees and teas flavored with milk.

According to another preferred embodiment, the process of preparing the beverage is visible to the consumer. To this end, the machine includes a transparent window (4) that reveals the area (5) in which all or part of the process of extracting espresso coffee, brewing coffee or tea, and preparing any number of other beverages occurs. The transparent window, or process window, allows consumers and service technicians alike to monitor the preparation of the beverage, which is particularly useful in the apparatus of this invention because the visible aspects of the processes used to prepare beverages such as espresso beverages, coffee press beverages, and vacuum pot beverages are sophisticated enough to warrant use of a multi-faceted monitoring system, particularly where such a monitoring system allows the proper preparation of the beverage to be confirmed visually. In the case of espresso beverages, for example, the grinding, tamping, and/or extraction of ground coffee might occur in area (5), using apparatus known to be useful in preparing espresso beverages. The key elements of the espresso process, which according to a presently preferred embodiment are viewed by the consumer or service technician, are as follows. These elements also are useful in distinguishing espresso extraction from the simpler infusion brewing process: 1) grinding coffee much more finely (e.g., fine enough that about 7 grams can cover an area of about 3 square feet); 2) tamping (packing) the ground coffee to a specific pressure range (e.g., from about 30 lbs. to about 40 lbs. per serving); 3) heating water to a higher, narrower temperature range (e.g., from about 88° C. to about 92° C.); 4) forcing heated water through the coffee grounds at a specific pressure range (e.g., from about 9 to about 10 atmospheres); and 5) reducing the extraction time (e.g., from about 25 to about 28 seconds). This espresso process can also be used to prepare beverages that are neither espresso nor infusion beverages. This is done by using a different setting for one or more of the elements of the process set forth above (e.g., pressurized water is still forced through the coffee grounds, but at a pressure range of 6 to 8 atmospheres, or other different settings.)

In the case of preparing other beverages, area (5) may also include other apparatus adapted for preparing beverages using, for example, an infusion brewing device, a French press or coffee press device, or a vacuum pot device. Infusion brewing is done by adding the flavoring medium (such as coffee or tea) to a brewing chamber, where gravity causes unpressurized hot water to flow through the medium, thereby infusing the water with flavor. French presses or coffee presses operate by stirring a solution of the main flavoring medium (e.g., coffee grounds) and hot water, followed by forcing a plunger through the solution. Vacuum pots operate using an upper and a lower chamber. When the water in the lower chamber is heated, the water reaches the coffee grounds held in the upper chamber. When a vacuum is created in the lower chamber, the water returns to the lower chamber as ready-to-drink coffee. These apparatus are preferably also configured to allow the process used to prepare the beverage to be viewed by the consumer.

The beverage (which may include milk, cocoa powder, sugar, and/or other ingredients) is dispensed in an area (6a) that is preferably visible through a window (6b) that is opened and closed either automatically or manually to allow the consumer access to the beverage. The beverage preferably flows through a transparent spout (7), which optionally includes a milk steamer, before it is dispensed in a disposable cup (8) that sits on a platform (10). After the machine dispenses the beverage into the cup, the machine places a lid (9) either beside the cup or directly on the cup, tightly covering it via a standard dispensing machine adapted to accommodate one or more different standard lids. Optionally, the consumer may place his or her own cup into the beverage dispensing area as an alternative to receiving the beverage in a disposable cup. The beverage-dispensing area (6a) optionally includes an opaque sliding screen (11) that deploys automatically before the spout (7) with optional milk steamer undergoes an autosterilization flush, thereby preventing the consumer from witnessing the flush.

Various visible indicators are provided in the standalone, self-contained beverage vending machine, which include, without limitation, temperature, pressure, weight, and other indicators, as well as indicators of the last date that one or more of the ingredients were replenished, and the date of last service (1a, 1b, 1c, 1d, 1e, 2, 3a, 3b, 4, 5, 6a, 6b, 7, 12, 16, 17, 18, 19). These various indicators serve at least three objectives. First, they convey to the consumer the sophistication of the process and the freshness of the ingredients. Second, they prompt the consumer and/or service technician to request and/or provide service in most situations when it is necessary. Such situations include without limitation: exhaustion of supplies such as coffee beans, failure to reach proper espresso extraction or coffee/tea brewing temperature, uneven tamping surfaces, and extended time between service visits to the machine. Third, they simplify and improve the quality-control monitoring and adjustments that service technicians perform by providing a better indication of services needed for optimum performance. These displays (physical and virtual) are especially useful in the context of preparing beverages using the espresso method, because the espresso method is different from infusion brewing, and much more complex, as discussed above. The windows therefore help to ensure that the beverage is being properly prepared.

A window that merely displays the brewing of beverages is adequate to monitor the quality of infusion beverages such as regular brewed coffee. However, such a window is an entirely inadequate vehicle to allow proper monitoring of the beverage preparation process for more complex non-infusion beverages, including without limitation beverages prepared using a press method, vacuum-pot method, espresso method, etc. Under such conditions, the three objectives set forth above are best met through the use of one or more of the indicators (1a, 1b, 1c, 1d, 1e, 2, 3a, 3b, 4, 5, 6a, 6b, 7, 12, 16, 17, 18, 19). Also, these monitoring means are useful where the beverage-preparation process has much narrower tolerances than the infusion process. For example, good coffee brewed using the infusion method is not very sensitive to the coarseness of the grind or how the grounds are placed in the brew basket. In contrast, espresso beverages are highly sensitive to the coarseness of the grind, and the evenness and pressure of the tamping. One or more windows (4) allow the customer and the service technician alike to verify, for example, that the coffee is ground properly and that the tamper surface is both level and perfectly smooth by viewing these from a window (5).

The machine also optionally includes at least one area (12) in which one or more displays clearly convey, describe, and/or quantify one or more aspects of the beverage-preparation process. These aspects may include, without limitation, the pressure of the tamping, the temperature of the brewing and/or extraction process, the duration of the brewing or extraction, addition of optional ingredients, etc. There is also preferably an area (13) for receiving consumer beverage selection input, preferably through a computer touch-screen. This area (13) preferably allows the consumer to customize various attributes of the beverage, such as how much milk to include, the amount and type of sweetener to include, and the temperature at which the beverage is prepared. Such selections by the consumer may also actuate different amounts of beverage being dispensed into the cup.

The machine may include a storage area (15) that houses an integrated water filtration system and/or standalone water tank or supply, and separately, a refrigerated milk chamber with a system that is capable of handling multiple containers of at least two types of fresh milk (e.g., whole, skim, nonfat). A standalone water tank/supply allows the machine to operate without necessitating that it be connected to an external plumbed water source. Where such a water source is used, the service technician replenishes the water during service visits. The storage area (15) can be accessed by the service technicians, but not consumers. The water filtration system and/or standalone water tank/supply, as well as the refrigerated milk chamber, may or may not be visible to the consumer. As shown in FIG. 1, both are visible to consumers through windows (16) and (17), respectively.

The machine preferably has one or more tiny vents (18, 19—greatly magnified in FIG. 1), that can be closed automatically or manually, through which the aromas of the ingredients and/or the beverage can escape. The aromas may be actively propelled to the outside to attract consumer by utilizing one or more small fans that run when the vents (18, 19) are open.

The consumer may optionally be requested to pay for the beverage with coins, bills, credit cards, and/or other forms of payment by a payment system (14). Such payment systems are well-known, and allow consumers to quickly and easily pay for their selected beverage without requiring cash or exact change. Other forms of payment linked to personal debit accounts or credit accounts are also contemplated, and the invention is not limited to any particular payment method.

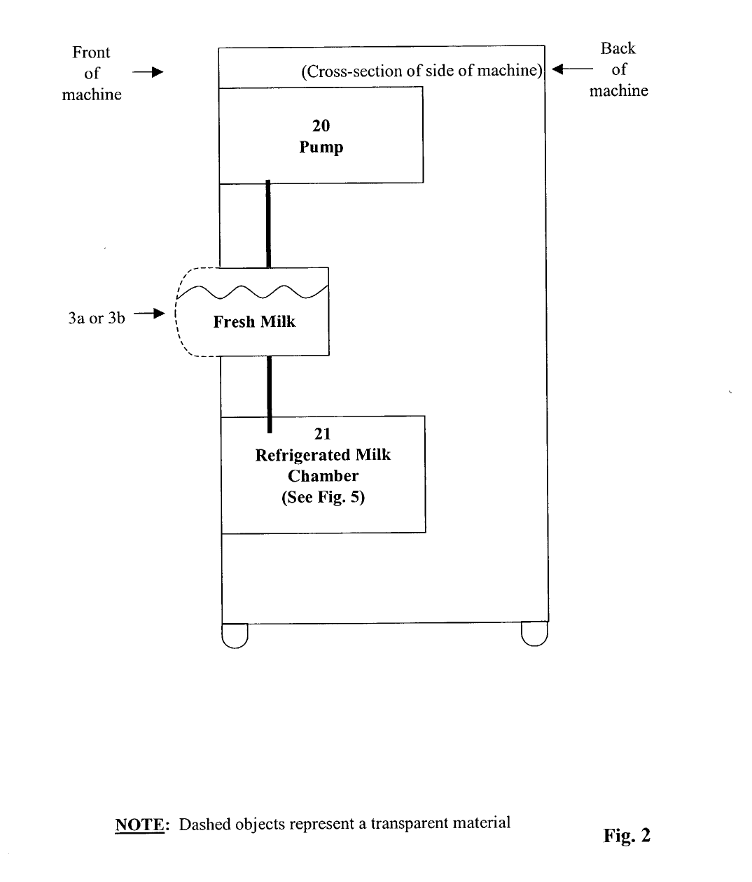

The cross-section view of the side of the machine in FIG. 2 offers an example of how fresh dairy products may be displayed. A see-through or transparent refrigerated milk vessel (see 3a, 3b of FIG. 1) is positioned, for example, between an optional pump (20) and a refrigerated milk chamber (21). The front of the vessel allows a clear view of the refrigerated milk held inside the vessel. The vessel can hold an arbitrary amount of milk (e.g., the amount needed to prepare one beverage), or can be calibrated to serve as a sight glass that represents the overall level of milk remaining in the refrigerated milk chamber (21). The vessel preferably holds the milk itself, and not a container of milk, in order to facilitate viewing of the freshness of the milk.

These transparent refrigerated milk vessels are advantageously included in the sterilization cycles of the rest of the milk-delivery system (described below herein). Such cycles may be manual (initiated by the service technician) and/or automatic (initiated, for example, after every drink is produced and/or at predetermined intervals when the machine is idle). The sterilization cycles are performed via standard sterilization techniques used in milk-delivery systems. These techniques may include without limitation the flushing of hot water, with or without chemical cleaning agents contained therein, through the entire milk delivery system.

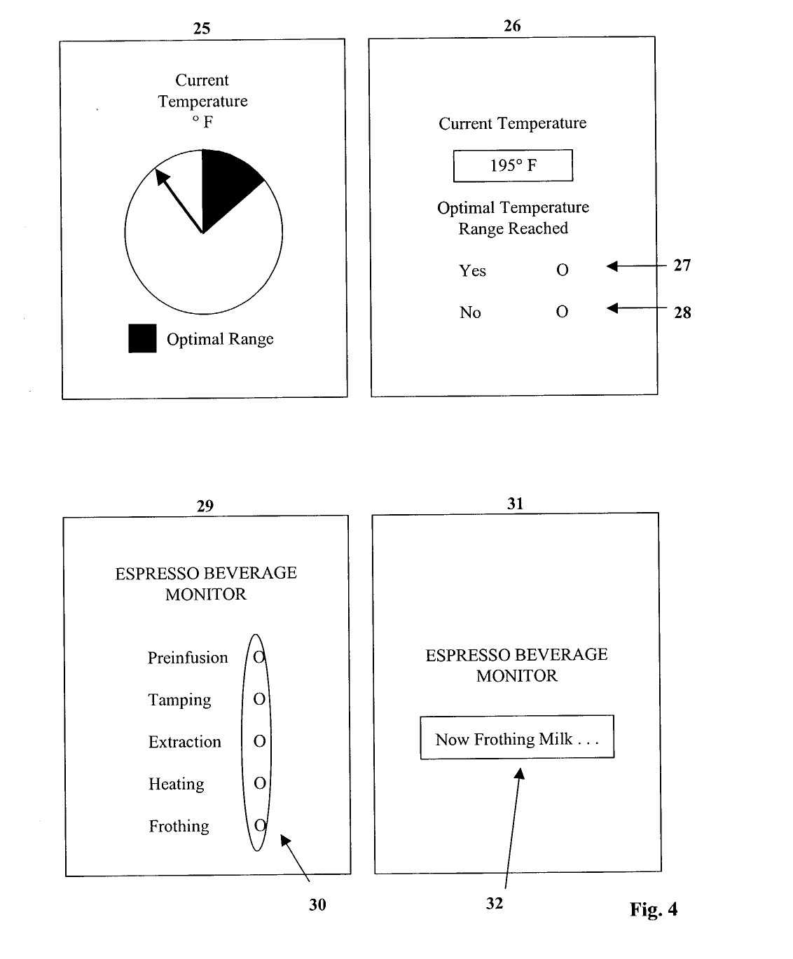

FIGS. 4a-4d show examples of the one or more displays placed in the display area (12). The displays can assume a variety of forms, as long as they clearly convey, describe, and/or quantify one or more key aspects of the beverage-preparation process. The aspects to be conveyed, described, and/or quantified include, without limitation, one or more of: milk storage temperature, milk heating temperature, water purity, espresso extraction time, espresso extraction temperature, and espresso extraction pressure. For example, an analog display (25) and a digital display (26) indicate the ideal extraction temperature range and the actual temperature under which espresso is being extracted. The digital display (26) includes two lights (27, 28) that indicate whether the optimal temperature range has been reached. Further examples are provided by display (29), which may include an array of lights (30) that indicate the process being performed, or display (31), which performs a similar function through a digital readout (32).

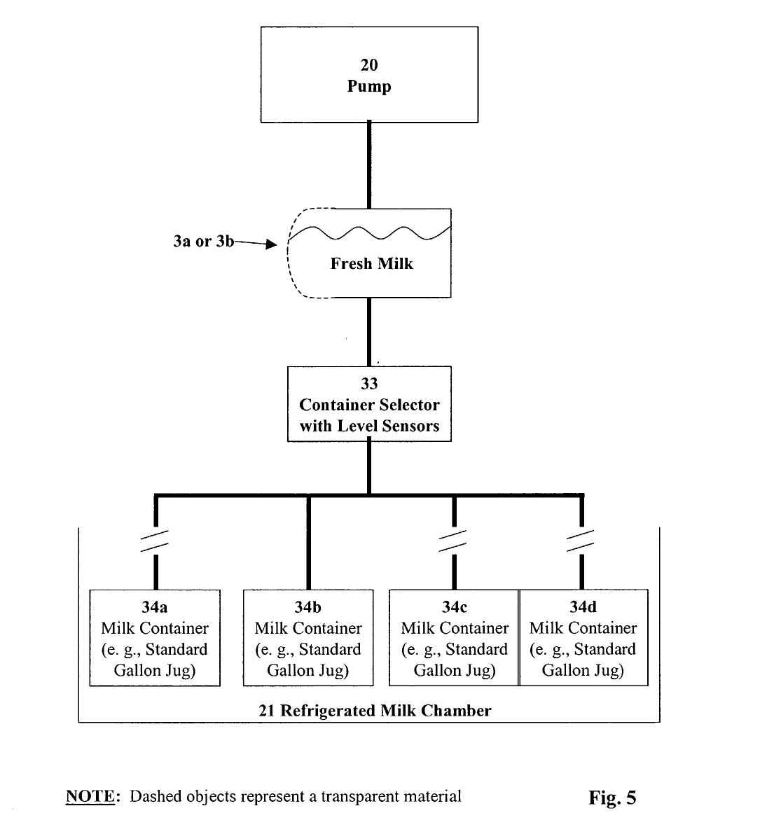

FIG. 5 illustrates one of the apparatus used to accommodate one or more containers of milk. Each vending machine ordinarily accommodates one such apparatus for each different type of milk provided (e.g., whole, nonfat, etc.). The milk containers (34a-d), typically standard bag-in-box containers or gallon jugs, are placed in a refrigerated milk chamber (21). Each milk container feeds into a container selector having a level sensor (33). Examples of possible level sensors (33) include, without limitation, a counter that tracks the volume of milk that has been dispensed, a scale that weighs the container being used, and a sensor that measures the pressure of the milk being delivered. The container selector only allows the optional pump (20) to draw milk from one container at a time, switching to a different container in a predetermined order once the current milk container has been exhausted. Use of a pump (20) is optional because the refrigerated milk chamber (21) and the milk containers (34a-d), could be placed above the beverage preparation and dispensing areas, thereby allowing the milk to be delivered to milk vessels (3a, 3b) and the rest of the machine via force of gravity. In the embodiment illustrated in FIG. 5, the container selector allows the optional pump (20) or gravity feed to dispense milk from the container (34b), and when this container is exhausted the container selector allows the pump/gravity feed to dispense milk in a predetermined order (34c, 34d, 34a). The container selector thus allows for milk to be drawn in reverse order of expiration date, so that the freshest milk is drawn last. Preferably, the container selector also allows the service technician to select, during service visits, the specific milk container from which to start drawing next. In the event the vending machine includes different types of milk, the machine automatically takes into account the locations of the different types of milk when preparing the beverage. Alternatively, if the supply of a certain type of milk has been exhausted, the machine does not offer the specific beverage that requires that milk type.

3. The Process

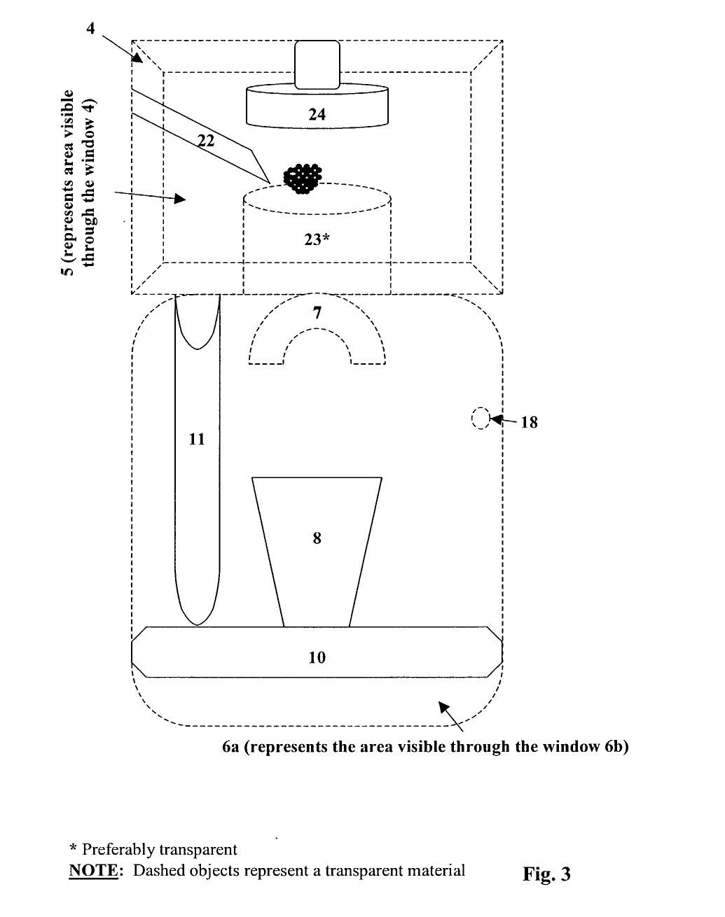

FIG. 3 is an example of the beverage-preparation process that window (4) reveals. This example is limited to the espresso process, but additional or more relevant elements can be added to area (5) to reveal the processes involved in preparing the other beverages offered by the machine. In this example, the freshly-ground coffee is delivered via a slide (22) to the coffee receptacle (23). Other standard means for delivering the coffee may alternatively be used. This coffee receptacle is made of a (preferably transparent) material that resists pressure and heat. After the ground coffee is delivered, the consumer watches as the mechanical tamper (24) tamps the coffee and the process of extracting espresso begins. The resulting beverage then flows through the spout (7), which optionally includes a milk steamer, into the disposable cup. The spout (7) is preferably made of heat-resistant transparent glass, preferably in the shape of a traditional espresso filter, as shown. The advantage of using such a shape is that it allows both the consumer and the service technician a better opportunity to evaluate the viscosity of the espresso coffee as it is being delivered into the disposable cup, as the viscosity of espresso coffee is a key indicator of the quality of the extraction process. Other standard means of transferring the fluid to the disposable cup may alternatively be used. Apparatus may also be employed to place a lid on or next to the disposable cup. In addition, in one alternative embodiment, the consumer may utilize his own cup to receive the beverage, and the beverage machine is configured to accept the consumer's cup and deliver the beverage therein.

The process of delivering the beverage to the consumer may also includes two additional preferred features. First, immediately after the beverage is dispensed into the cup (8), the beverage dispensing spout (7) retracts to prevent the consumer from touching it and thereby contaminating it. Second, after the window (6b) is opened (automatically or manually) so that the beverage may be retrieved from the dispensing area, a platform (10) slides out automatically towards the consumer, and retracts after a predetermined amount of time or after the machine senses that the beverage has been retrieved.

4. The System

The machine is designed to function for an extended period without the supervision of a service technician. As a result, the machine preferably includes (a) a system that monitors the quality of the beverages being prepared and makes adjustments to the machine when quality deteriorates; and/or (b) a system that enables the isolation of components or byproducts that are subject to bacterial contamination.

(a) The Quality Control System

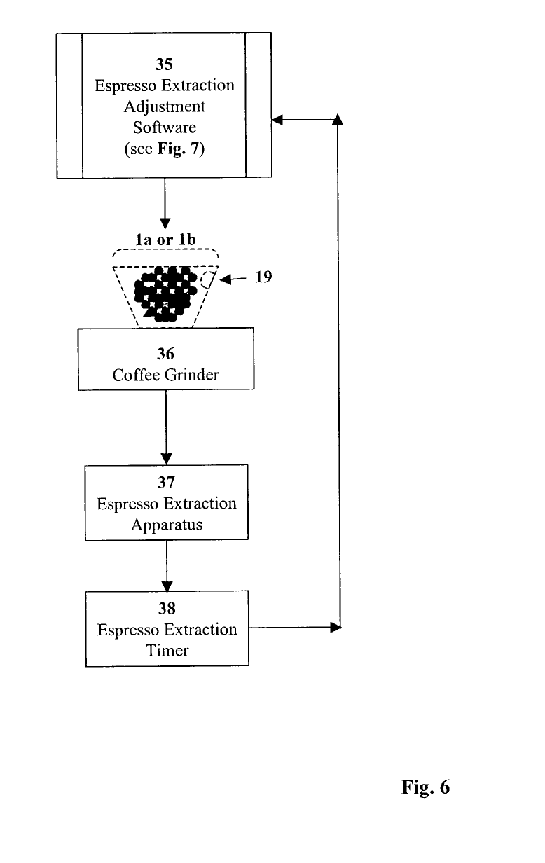

FIG. 6 illustrates a quality-control system for preparation of espresso; similar systems for the other beverages offered by the vending machine are preferably also included based on the particular sensitivity of the beverage preparation process being used. The system shown in FIG. 6 adjusts the coarseness setting of the coffee grinder depending on the espresso extraction time. The time for extracting espresso is an important indicator for determining whether there has been a proper extraction of espresso, e.g., some authorities believe that the optimal time is between 23-28 seconds, although this invention is not to be considered limited by any particular process parameters. At a given grinder setting, the extraction time can vary from day to day or even within a single day depending such factors as the humidity in the air and the coffee beans used. The system is driven by an espresso extraction adjustment software (35) that runs through one or more adjustment cycles. An adjustment cycle begins by grinding coffee in the grinder (36), and extracting espresso in the espresso extraction apparatus (37). An espresso extraction timer (38) measures the time that the extraction takes and communicates this time to the espresso extraction adjustment software (35).

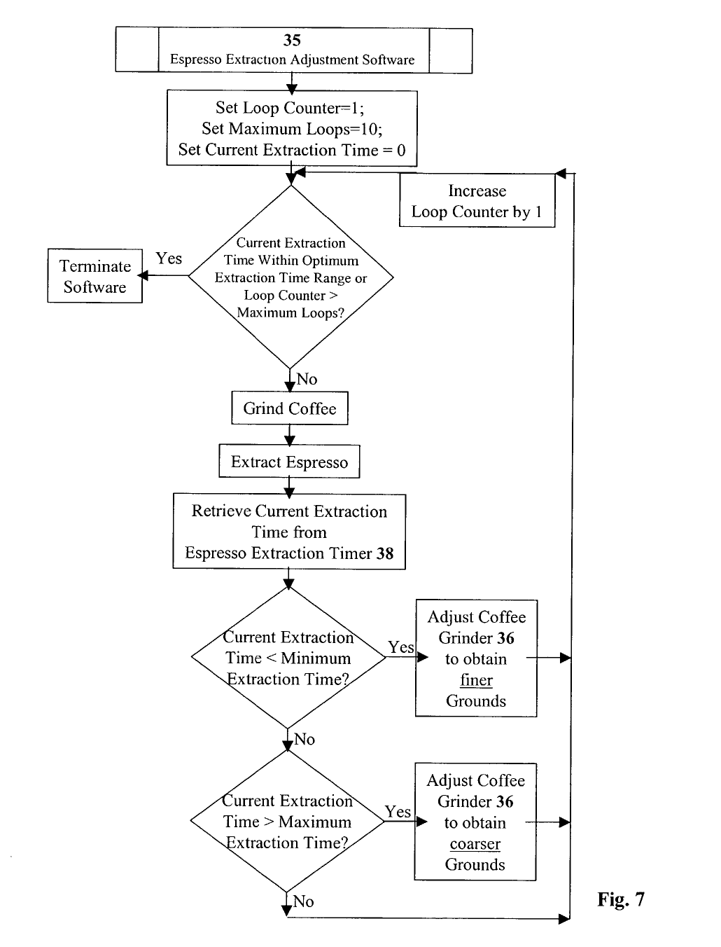

FIG. 7 outlines the operation of the espresso extraction adjustment software (35). The software determines whether to adjust the grinder to obtain finer or coarser grounds when espresso is being under-extracted or over-extracted, respectively. This software can be activated automatically at fixed intervals (e.g., every hour) or manually by the service technician. The software loop will continue to run until the espresso extraction time falls within the optimal range, or until it has run for a predetermined number of times. (In the example in FIG. 7, the software loop will not exceed 10 Adjustment Cycles.) The software may be embedded in firmware, floppy disk, CD, EEPROM, and may be updated locally or remotely via a network, such as the internet.

(b) Isolation of Components or By-Products Subject to Bacterial Contamination

Because the machine described herein is designed to function for extended periods without supervision, there is a possibility that bacteria may build up on or in certain components and in by-products or waste, particularly when fresh milk is used to prepare the beverages. Such contamination may occur in the beverage-preparation components of the system (such as the spout and/or steamer), in the ingredient storage areas (which may compromise beverage safety), or in the waste byproducts (which may cause the machine to emit unpleasant odors, even if beverage safety is not compromised).

The by-products that are susceptible to contamination with bacteria include, for example, small quantities of waste that drip from the spout (7), with or without the optional steamer, after an autosterilization flush or after the beverage has been prepared and the cup has been removed by the consumer. These by-products should be stored, for example, in a sealed container, or an open container that is maintained at low temperatures, preferably near freezing, and most preferably between 34 and 38° F. Container contents would be removed periodically by the service technician.

Ideally, the beverage preparation components should not be subject to bacterial build-up. First, bacteria should not develop because such components should be kept at very low temperatures. Second, any minor levels of bacteria that do occur should be eliminated through periodic autosterilization flushes. For example, any component that comes into contact with dairy products (such as the container selector with level sensors (33), and the spout (7) with optional steamer) should be kept at low temperatures, preferably near freezing, and most preferably between 34 and 38° F. In practice, however, bacteria may still grow. For example, it may not be easy to keep the tip of the spout or the steamer at consistently low temperatures, and autosterilization flushes may merely delay, rather than prevent, the buildup of bacteria. If such is the case, it is desirable to replace those components that are most vulnerable, such as the spout and the steamer. However, the invention is not limited to replacement of these specific components, rather, any component subject to contamination may be replaced.

The beverage preparation components that are most susceptible to bacterial build-up, such as the spout (7), with optional steamer, may be automatically replaced periodically between visits by the service technician, at fixed intervals and/or after a certain number of beverages have been dispensed. Such components would be discarded automatically and replaced by fresh, uncontaminated components. Alternatively, the parts may be replaced by the service technician as part of ordinary maintenance of the machine. If replaced automatically, the components could be placed into a sealed container, which may or may not be refrigerated, and later retrieved by the technician for later thorough cleaning and reuse, or disposal. The replacement parts may be installed by a variety of mechanisms, including without limitation a revolving cylinder.

5. Advantageous Features

Advantageous features according to the preferred embodiments include one or more of the following:

ability to prepare beverages using fresh dairy products;

providing beverages to consumers in a cup with a lid;

conveying the beverage preparation process (both quantifiable and observable aspects) and ingredient freshness to the consumer;

monitoring and adjusting the beverage preparation to ensure the quality of the beverage being produced;

providing a quality control feedback system for obtaining customer satisfaction information; and

preventing the build-up of bacteria in key beverage preparation components and beverage by-products.

6. Conclusion

Thus, what has been described is an apparatus and method for vending beverages, as well as software and method for monitoring and adjusting the extraction of espresso. By utilizing the apparatus, software, and associated methods described herein, beverages exhibiting improved quality and freshness are provided, and the experience of the recipient of the beverage is enhanced.

The individual components shown in outline or designated by blocks in the attached Drawings are all well-known in the vending machine, espresso preparation, or other relevant arts, and their specific construction and operation are not critical to the operation or best mode for carrying out the invention.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

For example, the specific sequence of the above described process may be altered so that certain processes are conducted in parallel or independent, with other processes, to the extent that the processes are not dependent upon each other. Thus, the specific order of steps described herein are not to be considered implying a specific sequence of steps to perform the above described process. Other alterations or modifications of the above processes are also contemplated. For example, further insubstantial approximations or modifications of the above processes are also considered within the scope of the processes described herein.

All U.S. and foreign patent documents discussed above are hereby incorporated by reference into the Detailed Description of the Preferred Embodiment.

While the present invention has been described with respect to what is presently considered to be the preferred embodiments, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. A self-contained, standalone apparatus for automatically preparing and vending beverages based on selections input by consumers, comprising:
(a) one or more sources of roasted coffee beans;
(b) one or more sources of tea;
(c) one or more sources of cocoa;
(d) at least one grinder for preparing ground coffee from said roasted coffee beans;
(e) one or more sources of flavoring ingredients;
(f) a source of water;
(g) one or more sources of fresh dairy products; and
(h) a mechanism for preparing the beverage.

2. The apparatus of claim 1, wherein said beverages are espresso beverages.

3. The apparatus of claim 1, wherein said beverages are provided in a cup with a lid.

4. The apparatus of claim 1, wherein said sources of roasted coffee beans, teas, cocoa, flavoring ingredients, and fresh dairy products are visible to a consumer.

5. The apparatus of claim 4, wherein the freshness of one or more of the roasted coffee beans, flavoring ingredients, and fresh dairy products are displayed to the consumer.

6. The apparatus of claim 1, wherein said roasted coffee beans are selected from the group consisting of flavored beans, decaffeinated beans, and regular beans.

7. The apparatus of claim 1, wherein said flavoring ingredients are selected from the group consisting of sugar, artificial sweeteners, and flavored liqueurs.

8. The apparatus of claim 1, wherein said fresh dairy products are selected from the group consisting of skim milk, reduced fat milk, whole milk, half-and-half, and cream.

9. The apparatus of claim 1, wherein said source of water includes a water filtration apparatus.

10. The apparatus of claim 1, wherein the apparatus further includes a payment collection system.

11. The apparatus of claim 10, wherein said payment collection system accepts payment forms selected from the group consisting of cash, credit, and debit.

12. The apparatus of claim 1, wherein the selections are input by consumers into a computer, said computer comprising:
(a) a processor;
(b) a display area;
(c) at least one input device; and
(d) a memory apparatus storing computer-readable code for implementing a preparation routine corresponding to the selections input by the customer and operating said mechanism for preparing the beverage in accordance with said preparation routine.

13. A self-contained espresso beverage vending device, said vending device comprising a mechanism for preparing the espresso beverage, said mechanism comprising:
(a) means for monitoring the preparation of the selected beverage;
(b) means for storing preset standards for proper preparation of the selected beverage; and
(c) means for comparing the monitored preparation of the beverage with the stored standards for preparation of the beverage, and adjusting the preparation of the beverage so that said beverage is prepared in compliance with the standards.

14. The apparatus of claim 14, wherein said mechanism for preparing the beverage further comprises means for indicating that the apparatus is not capable of adjusting the preparation of the beverage in compliance with the standards, and that service to the apparatus is required.

15. A feedback system for monitoring a standalone beverage vending apparatus, said system comprising:
(a) means for requesting that information be input to indicate a degree of satisfaction with one or more aspects of the apparatus selected from the group consisting of quality of beverage, quality of ingredients, and satisfaction with value received;
(b) means for inputting the requested information regarding consumer satisfaction; and
(c) means for preparing a summary of information input by consumer.

16. A method for automatically preparing a beverage according to beverage selections entered by a consumer, comprising the steps of:
(a) receiving the beverage selections entered by a consumer;
(b) retrieving preset standards for proper preparation of the beverage based on the beverage selections input by the consumer;
(c) displaying to the consumer the beverage preparation process and the freshness of ingredients being used to prepare the beverage;
(d) preparing the beverage in accordance with the preset standards;
(e) monitoring the preparation of the beverage to ensure that said beverage is prepared in compliance with the preset standards; and
(f) providing said beverage to the consumer.

17. The method of claim 16, further comprising the step of requesting feedback regarding satisfaction with the beverage, and recording said feedback.

18. The method of claim 16, wherein said beverages are prepared using a method selected from the group consisting of infusion, espresso, coffee press, and vacuum press.

19. The method of claim 16, wherein said beverages are provided to the consumer in a cup with a lid.

20. The method of claim 16, wherein said beverages are prepared using fresh dairy products.

21. The method of claim 20, wherein said fresh dairy products are selected from the group consisting of skim milk, reduced fat milk, whole milk, half-and-half, and cream.

22. The method of claim 16, further including the step of collecting payment for the beverage based on the beverage selections entered, said payment being selected from the group consisting of cash, credit, and debit.

23. The method of claim 16, wherein the steps of preparing the beverage and monitoring the beverage preparation allow adjustment of the preparation of the beverage so that said beverage is prepared in compliance with the standards.

24. A computer system for monitoring and adjusting the production of beverages, comprising:
(a) sensors for detecting actual status of all sources of ingredients used in preparing a selected beverage;
(b) sensors for monitoring actual functioning and actual status of mechanisms during preparation of the selected beverage;
(c) memory comprising stored software including preset status and preset functioning information corresponding to the selected beverage; and
(d) a processor for comparing the actual status and actual functioning of the ingredients and mechanisms involved in beverage production to the preset status and preset functioning of the ingredients and mechanisms stored in memory,
wherein when the actual functioning and the actual status of the mechanisms used to prepare the beverage are not substantially identical to the preset functioning and preset status, a message is delivered to the mechanisms indicating adjustments to be made for the preparation of the beverage.

25. A cleaning system for use in an automatic, self-contained beverage vending machine that prepares beverages using fresh dairy products, said system comprising:
a sterilization flusher for providing a cleaning flush of beverage preparation components contained in said vending machine; and
a receptacle for storing waste generated during the cleaning flush, as well as fluids leaked from the beverage preparation components during preparation of the beverage.

26. The cleaning system of claim 25, wherein the cleaning flush is conducted using a fluid comprising water.

27. The cleaning system of claim 26, wherein the cleaning flush fluid further comprises an antibacterial agent.

28. The cleaning system of claim 25, wherein the receptacle for storing waste is sealed after it is filled with cleaning flush fluid.

29. The cleaning system of claim 28, further comprising rotating means for removing the filled, sealed receptacle and replacing it with a new, empty receptacle.

30. The cleaning system of claim 29, wherein the receptacle for storing waste is refrigerated.

31. The cleaning system of claim 25, further comprising a receptacle for storing replaceable components subject to bacterial contamination.
